(19) United States
(12) Patent Application Publication
(10) Pub. No.: US 2018/0019480 A1
(43) Pub. Date: Jan. 18, 2018

(54) Battery with open bottom

(71) Applicant: Zhangjiagang Ou-De Battery Technology Co., Ltd., Suzhou (CN)

(72) Inventors: Runzhi MA, Suzhou (CN); Jian SHI, Suzhou (CN)

(73) Assignee: Zhangjiagang Ou-De Battery Technology Co., Ltd., Suzhou (CN)

(21) Appl. No.: 15/488,524

(22) Filed: Apr. 17, 2017

(30) Foreign Application Priority Data
Jul. 14, 2016 (CN) 201610554426.0

(51) Int. Cl. H01M 6/38

(52) U.S. Cl. CPC H01M 6/385

(57) ABSTRACT

Disclosed is a battery with an open bottom, comprising a battery assembly and an electrolyte storage box for accommodating an electrolyte. Said battery assembly comprises at least one battery pack, and said at least one battery pack can move between a first position and a second position relative to said electrolyte storage box; in the first position, said at least one battery pack contacts said electrolyte so as to enable said battery with an open bottom to generate electricity, and in the second position, said at least one battery pack is separated from said electrolyte such that said battery with an open bottom is turned off. The battery pack of the battery with an open bottom in the present invention can move between the first and the second positions relative to the electrolyte storage box so as to rapidly contact and react with the electrolyte.

### CROSS REFERENCE TO RELATED APPLICATIONS

This application claims priority to Chinese Patent Application No. CN201610554426.0, filed on Jul. 14, 2016, the entire contents of which are incorporated herein by reference.

### TECHNICAL FIELD

The present invention relates to a battery, especially a battery with an open bottom.

### BACKGROUND

With the development of science and technology, the application of batteries becomes increasingly extensive in various fields. Generally, a battery generates current by means of the reaction between an electrolyte and electrodes. In the prior art, in order to control the turning on and off of a battery, the electrolyte is often injected into a reaction chamber to enable the reaction between electrodes and the electrolyte so as to generate current, and when the battery needs to be turned off, the electrolyte will be drawn out of the reaction chamber. With such battery control mode, it is possible that the electrolyte may not be completely drawn out of the reaction chamber, causing the electrodes to still react with the residual electrolyte when the battery is turned off. Moreover, the time taken for the battery to generate power at full capacity and shut down may be long, and rapid power generation and shut down cannot be realized.

### SUMMARY OF THE INVENTION

In order to overcome the drawbacks in the prior art, an object of the present invention is to provide a battery with an open bottom.

The object of the present invention is achieved through the following technical solution:

A battery with an open bottom comprises a battery assembly and an electrolyte storage box for accommodating an electrolyte. Said battery assembly comprises at least one battery pack, and said at least one battery pack can move between a first position and a second position relative to said electrolyte storage box. In the first position, said at least one battery pack contacts said electrolyte so as to enable said battery with an open, bottom to generate electricity; and in the second position, said at least one battery pack is separated from said electrolyte such that said battery with an open bottom is turned off.

Preferably, said battery with an open bottom further comprises a control device. When said at least one battery pack is in the first position, said control device is snap-fitted with said battery assembly and said electrolyte storage box, such that said battery assembly is fixed in said electrolyte storage box and reacts with said electrolyte. When said at least one battery pack is in the second position, said control device is unlocked from said electrolyte storage box, such that said battery assembly is separated from said electrolyte storage box and from said electrolyte.

Preferably, said at least one battery pack comprises a battery main body and is provided with a reaction chamber. Said reaction chamber is connected to said electrolyte storage box, and said battery main body is located inside said reaction chamber.

Preferably, said at least one battery pack further comprises an air chamber connected to said reaction chamber, and a first opening and a second opening which are both connected to said air chamber. Air enters said air chamber from said first opening and passes through said air chamber to react with said battery main body inside said reaction chamber, and said air is discharged from said at least one battery pack via said second opening.

Preferably, said at least one battery pack is further provided with a condensed water collection volume, and said condensed water collection volume is located on the side of said air chamber close to said second opening.

Preferably, said battery assembly comprises a plurality of battery packs and an upper cover, wherein said upper cover is provided with an air inlet and an air outlet, the first opening of one of said plurality of battery packs is connected to said air inlet, and the second opening of one of said plurality of battery packs is connected to said air outlet.

Preferably, said plurality of battery packs is mounted on said upper cover in sequence, the first and second openings of each of said battery packs correspond to the first and second openings of an adjacent one of said battery packs so as to realize the ventilation inside said plurality of battery packs.

Preferably, said at least one battery pack comprises at least one lower division plate, and the distance front a lower end of said at least one lower division plate to the bottom of said electrolyte storage box is 1-50 mm.

Preferably, the height of said lower division plate is 30-300 mm.

Preferably, said at least one battery pack comprises at least one upper division plate, and the height of said upper division plate is 30-300 mm.

Compared with the prior art, the beneficial effects of the present invention are as follows:

The at least one battery pack of the battery with an open bottom in the present invention can move between the first and the second positions relative to the electrolyte storage box so as to rapidly contact and react with the electrolyte and enable the battery to generate electricity or to be rapidly separated from the electrolyte for turning off the battery.

### BRIEF DESCRIPTION OF DRAWINGS

FIG. 1 is a perspective view of a battery with an open bottom in the present application.

FIG. 2 is a schematic structural view of the battery with an open bottom shown FIG. 1.

FIG. 3 is a perspective view of a battery pack of the battery with an open bottom shown FIG. 2.

FIG. 4 is a schematic view of the battery pack shown in FIG. 3 in an operational state.

In the figures: 100. battery with an open bottom; 10. electrolyte storage box; 20. battery assembly; 22. upper cover; 220. air inlet; 222. air outlet; 24. battery pack; 240. battery main body; 241. first opening; 242. air chamber; 243. second opening; 244. reaction chamber; 246. condensed water collection volume; 247. upper division plate; 248. lower division plate; 30. electrolyte; 40. control device; 42. snap-fit part.

### DETAILED DESCRIPTION

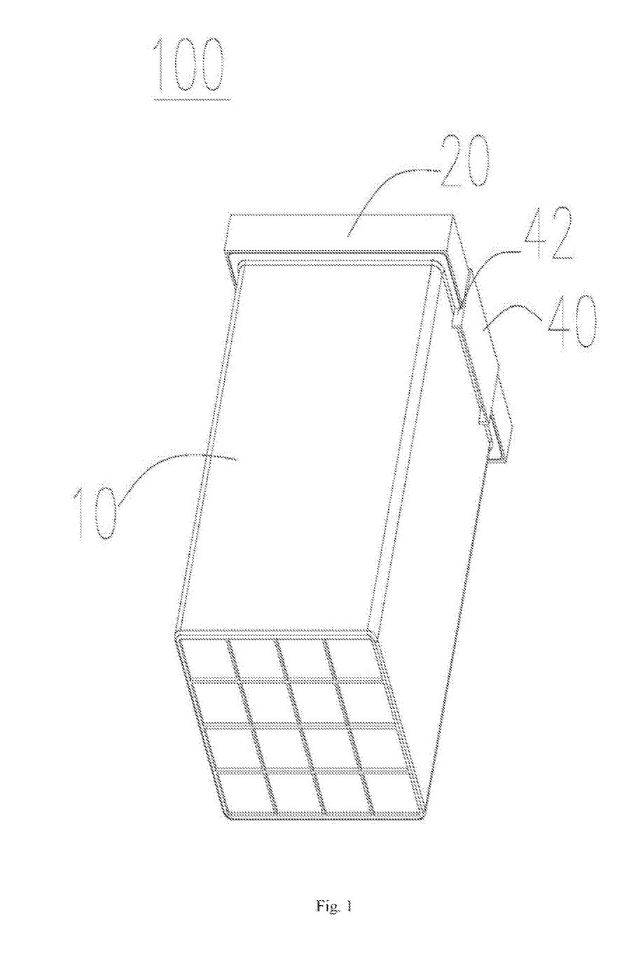

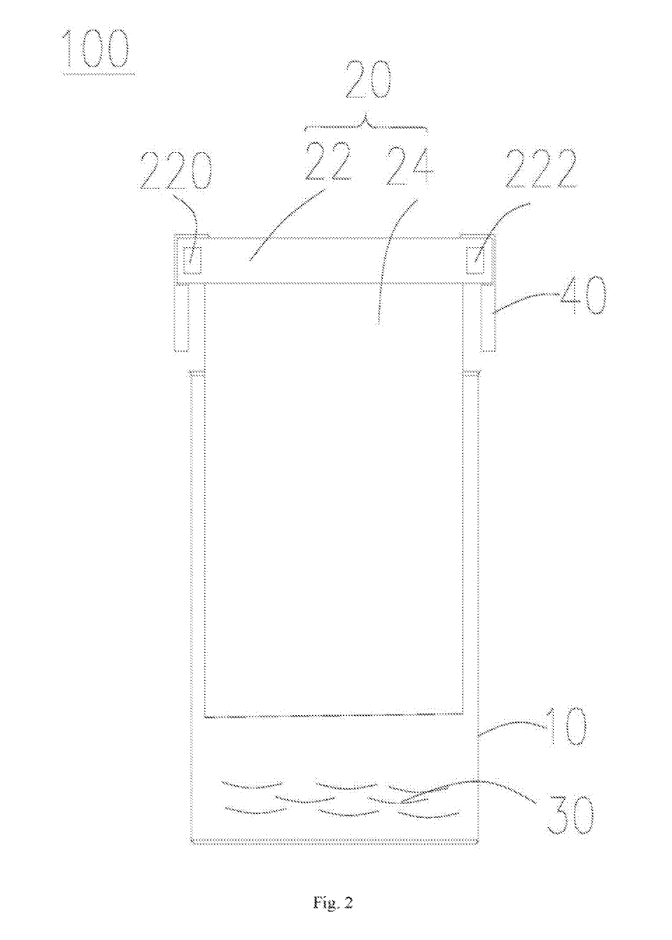

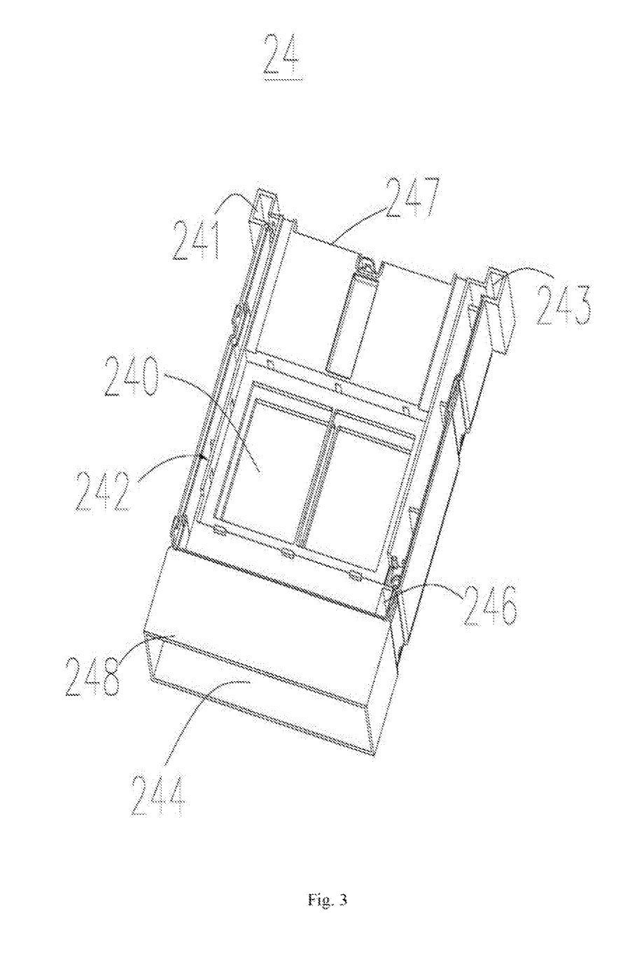

With reference to FIG. 1 to FIG. 3, a battery with an open bottom 100 comprises an electrolyte storage box 10, a battery assembly 20 and two control devices 40. Said electrolyte storage box 10 is used to accommodate an electrolyte 30.

Said battery assembly 20 comprises an upper cover 22 and a plurality of battery packs 24. Said upper cover 22 is provided with an air inlet 220 and an air outlet 222. Each of said battery packs 24 comprises a battery main body 240, an upper division plate 247, and a lower division plate 248. Each of said battery packs 24 is provided with a first opening 241, an air chamber 242, a second opening 243, a reaction chamber 244 and a condensed water collection volume 246. Said first opening 241 and said second opening 243 are connected to said air chamber 242. Said air chamber 242 is connected to said reaction chamber 244. Said battery main body 240 is located inside said reaction chamber 244. Said condensed water collection volume 246 is located on a side of said second opening 243. In one embodiment, the height of said upper division plate 247 and said lower division plate 248 is 30-300 mm. Each of said control devices 40 is provided with a snap-fit part 42.

When assembling said battery with an open bottom 100, said plurality of battery packs 24 are mounted on said upper cover 22, and the first opening 241 and said second opening 243 of each of said battery packs 24 correspond to the first opening 241 and said second opening 243 of an adjacent battery pack 24. The first opening 241 of said battery pack 24 is connected to the air inlet 220 of said upper cover 22. The second opening 243 of said battery pack 24 is connected to the air outlet 222 of said upper cover 22. In one embodiment, said plurality of battery packs 24 is arranged substantially in parallel.

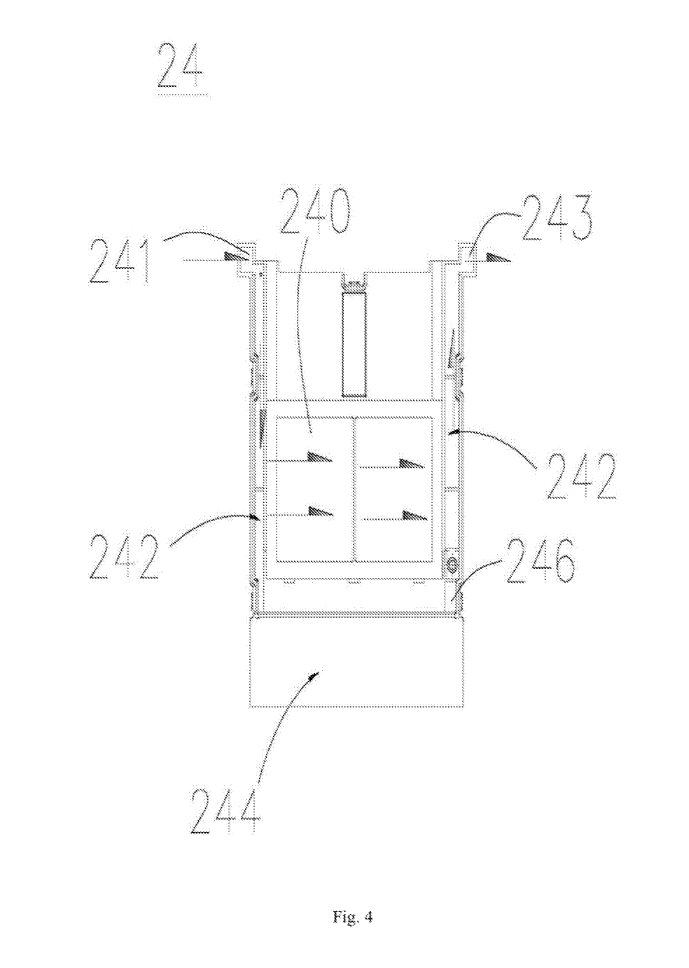

With futher reference to FIG. 4, when said battery with an open bottom 100 is in use, said electrolyte 30 is accommodated in said electrolyte storage box 10, one end of each of said control devices 40 contacts said upper covers 22, and said snap-fit part 42 is snap-fitted with said electrolyte storage box 10. At this time, said battery assembly 20 is fixed in said electrolyte storage box 10, and said electrolyte 30 enters said reaction chamber 244 to react with said battery main body 240. The air coming from said air inlet 220 flows inside said plurality of battery packs 24. Said plurality of battery packs 24 is located in a first position relative to said electrolyte storage box 10. Said battery with an open bottom 100 generates electricity. The vapor generated when said battery main body 240 reacts with said electrolyte 30 and the air flows along with said air to said condensed water collection volume 246. At this time, the distance from a lower end of said lower division plate 248 to the bottom of said electrolyte storage box 10 is 1-50 mm.

When said battery with art open bottom 100 is to be turned off, said two control devices 40 are unlocked from said electrolyte storage box 10. Said battery assembly 20 moves to a second position relative to said electrolyte storage box 10 under the action of the buoyancy force from said electrolyte 30. At this time, said plurality of battery packs 24 is separated from said electrolyte 30, and said battery with an open bottom 100 is turned off.

Said battery pack 24 of said battery with an open bottom 100 can move between said first and second positions relative to said electrolyte storage box 10 so as to rapidly contact and react with said electrolyte 30 and enable said battery 100 to generate electricity or to be rapidly separated from said electrolyte 30 for turning off said battery 100.

For a person skilled in the art, a variety of other corresponding modifications and variations can be made according to the above-described technical solutions and concepts, and all the modifications and variations shall fail within the scope of protection of the claims of the present invention.

1. A battery with an open bottom, comprising:
a battery assembly, wherein the battery assembly includes at least one battery pack;
an electrolyte storage box for accommodating an electrolyte;
wherein
the at least one battery pack can move between a first position and a second position relative to said electrolyte storage box;
in the first position, said at least one battery pack, contacts said electrolyte so as to enable said battery with an open bottom to generate electricity; and
in the second position, said at least one battery pack is separated from said electrolyte such that said battery with an open bottom is turned off

2. The battery with an open bottom according to claim 1, further comprising:
a control device;
wherein
when said at least one battery pack is in the first position, said control device is snap-fitted with said battery assembly and said electrolyte storage box, such that said battery assembly is fixed in said electrolyte storage box and reacts with said electrolyte; and
when said at least one battery pack is in the second position, said control device is unlocked from said electrolyte storage box, such that said battery assembly is separated from said electrolyte storage box and from said electrolyte.

3. The battery with an open bottom according to claim 1, wherein said at least one battery pack comprises:
a battery main body; and
a reaction chamber;
wherein
said reaction chamber is connected to said electrolyte storage box; and
said battery main body is located inside said reaction chamber.

4. The battery with an open, bottom according to claim 3, wherein said at least one battery pack further comprises:
an air chamber connected to said reaction chamber; and
a first opening and a second opening which are both connected to said air chamber;
wherein
said air chamber is configured to let air enter front said first opening;
said battery main body is configured to be isolated from said electrolyte by said air chamber; and
said at least one battery pack is configured to discharge the air via said second opening.

5. The battery with an open bottom according to claim 4, wherein said at least one battery pack further comprises:
a condensed water collection volume, for collecting the water generated during the exchange of hot air and cold air;
wherein said condensed water collection volume is located on the side of said air chamber close to said second opening.

6. The battery with an open bottom according to claim 4, wherein said battery assembly comprises:
a plurality of battery packs; and
an upper cover, provided with an air inlet and an air let;
wherein
the first opening of one of said plurality of battery packs is connected to said air inlet; and
the second opening of one of said plurality of battery packs is connected to said air outlet.

7. The battery with an open bottom according to claim 4, wherein
said plurality of battery packs is mounted on said upper cover in sequence; and
the first and second openings of each of said battery packs correspond to the first and second openings of an adjacent one of said battery packs so as to realize the ventilation inside said plurality of battery packs.

8. The battery with an open bottom according to claim 1, wherein
said at least one battery pack comprises at least one lower division plate; and
the distance from a lower end of said at least one lower division plate to the bottom of said electrolyte storage box is 1-50 mm.

9. The battery with an open bottom according to claim 8, wherein the height of said lower division plate is 30-300 mm.

10. The battery with an open bottom according to claim 8, wherein
said at least one battery pack comprises at least one upper division plate; and
the height of said upper division plate is 30-300 mm.
